(19) United States
(12) Patent Application Publication
(10) Pub. No.: US 2021/0015710 A1
(43) Pub. Date: Jan. 21, 2021

(54) Stackable Medication Crushing Container

(71) Applicant: Rebecca Sylvia Baum, Salt Lake City, UT (US)

(72) Inventor: Rebecca Sylvia Baum, Salt Lake City, UT (US)

(21) Appl. No.: 16/783,493

(22) Filed: Feb. 6, 2020

Related U.S. Application Data
(60) Provisional application No. 62/876,009, filed on Jul. 19, 2019.

(51) Int. Cl. A61J 7/00; B65D 21/02; B65D 21/04; A61J 1/03; B65D 1/40

(52) U.S. Cl. CPC A61J 7/0007; B65D 21/0233; B65D 21/048; B65D 2585/56; B65D 1/40; B65D 2203/04; A61J 1/03

(57) ABSTRACT

A stackable medication crushing container including a first medication container. The medication container includes a first set of indicia on a side of the medication container that depicts a measurement in milliliters. A second set of indicia is disposed on a side of the medication container that depicts a measurement in teaspoons and tablespoons. The medication container has a narrower base and a wider top opened section that will allow the container to be stackable. Further, the container includes a lid that creates a seal around the top opening. A crushing insert can be added to the bottom of a second container to allow medication to be crushed within the medication container.

### CROSS REFERENCE TO RELATED APPLICATIONS

This application claims the benefit of U.S. Provisional Application No. 62/876,009 filed on Jul. 19, 2019. The above identified patent application is herein incorporated by reference in its entirety to provide continuity of disclosure.

### BACKGROUND OF THE INVENTION

The present invention relates to transporting and taking medications. More particularly, the present invention provides a stackable medication container that can also crush a medication for easier consumption.

Many individuals take medications throughout the day. This requires individuals to carry medications with them. It can be difficult to store various medications and to transport them. Further, some medications need to be crushed and mixed with a liquid to be taken. This can further complicate the issue. It can be difficult to transport powder or to properly crush a medication.

Further, some medications are already in liquid form. This means that an individual will have to carry a measurement device and the medication. Many traditional liquid medications come with a plastic cup that is not capable of transporting a single dose of the medication. Further the cup only measures in milliliters and does not convert to teaspoons and tablespoons while the doses are prescribed in the latter.

Consequently, there is a need in for an improvement in the art of transporting and taking medication. The present invention substantially diverges in design elements from the known art while at the same time solves a problem many people face when transporting and taking medication. In this regard the present invention substantially fulfills these needs.

### SUMMARY OF THE INVENTION

The present invention provides a stackable medication crushing container wherein the same can be utilized for providing convenience for the user when using a medication container. The stackable medication crushing container includes a container having a base and a cylindrical sidewall. The cylindrical sidewall has an indicium placed vertically along the sidewall in at least two places. The container is configured to be placed within a second like container and fastened therein.

Another object of the stackable medication crushing container is to further include an opening with an interior volume located in an underside of the base.

Another object of the stackable medication crushing container is to further include an insert that is configured to be fit within the opening located on the underside of the base.

Another object of the stackable medication crushing container is to further include an insert that is a crushing insert, the insert is proportioned to fit flush within the interior of a second like container.

Another object of the stackable medication crushing container is to further include a lid that is capable of being removably secured to a top side of the container.

Another object of the stackable medication crushing container is to further include a first set of vertical indicia indicate the volume of the container in milliliters.

Another object of the stackable medication crushing container is to further include a first set of vertical indicia indicate the volume of the container in teaspoons and tablespoons.

Another object of the stackable medication crushing container is to taper the cylindrical wall inward from a top side of the container towards the base.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a side view of an embodiment of the stackable medication crushing container.

FIG. 1.13 shows a side view of an embodiment of the stackable medication crushing container.

FIG. 2 shows a perspective view of an embodiment of the stackable medication container with a lid.

FIG. 3 shows a side view of an embodiment of several stackable medication containers

FIG. 4 shows a side view of an embodiment of a pair of stackable medication containers with a crushing element.

### DETAILED DESCRIPTION OF THE INVENTION

Reference is made herein to the attached drawings. Like reference numerals are used throughout the drawings to depict like or similar elements of the stackable medication containers. For the purposes of presenting a brief and clear description of the present invention, a preferred embodiment will be discussed as used for the stackable medication crushing container. The figures are intended for representative purposes only and should not be considered to be limiting in any respect.

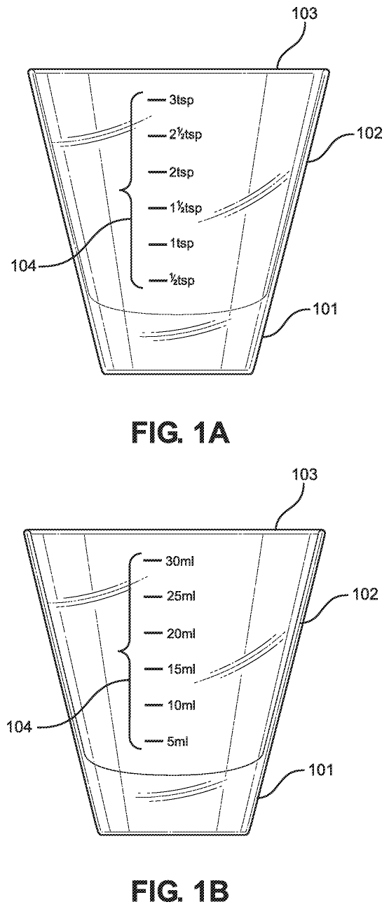

Referring now to FIG. 1A and FIG. 1B, there is shown a side view of an embodiment of the stackable medication crushing container. The stackable medication crushing container has a base 101 and a sidewall 102 that forms an open top side 103 and an interior volume. In one embodiment, the container is made from glass. In another embodiment, the container is made from plastic. In one embodiment, the plastic is an FDA approved plastic. The base 101 of the stackable medication crushing container has a flat bottom surface. This will allow the stackable medication container to stay upright when placed on a surface.

The sidewall 102 is connected to the base 101 and extends vertically upwards. In one embodiment, the sidewall 102 and the base 101 are cylindrical. In another embodiment, the sidewall 102 and the base are rectangular. In some embodiments, the sidewall 102 tapers inwardly from the open top side 103 of the container towards the base 101. In the embodiments where the sidewall 102 is rectangular, the tapering will be in a pyramidal shape. This will ensure that the container can fit into a like container.

The container has multiple indicia 104 placed vertically on the sidewall 102. The indicia 104 are placed at intervals representing a volume of the interior volume at that interval. In one embodiment, the indicia 104 represent the volume in milliliters. In another embodiment, the indicia 104 represent the volume in teaspoons and tablespoons. In yet another embodiment, the indicia 104 will indicate the volume in both milliliters and teaspoons and tablespoons. While the shown embodiment shows the indicia 104 located on opposite sides of the sidewall 102, in alternate embodiments, it is contemplated that the indicia 104 are located elsewhere along the sidewall, such as adjacent to each other.

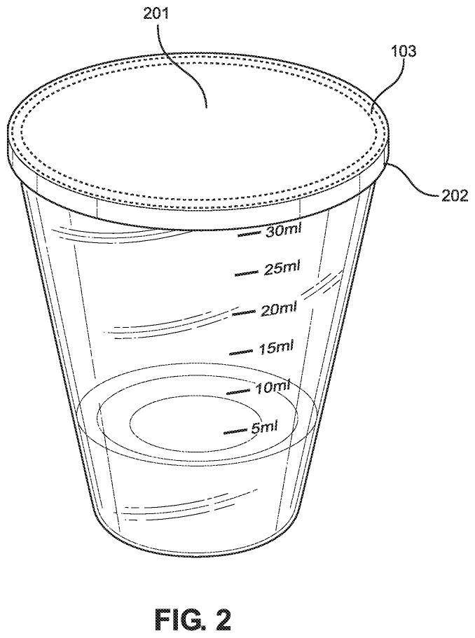

Referring now to FIG. 2, there is shown a perspective view of an embodiment of the stackable medication container with a lid. The stackable medication crushing container further comprises a lid 201 over the open top side 103. In the shown embodiment the lid 201 is comprised of a planar member having a lip extending orthogonally therefrom. The lip extended around the perimeter of the planar member. The lip is configured to frictionally engage the container. The lid 201 will enable a user to secure a medication within the container, ensuring that the medication is not lost during transport. In one embodiment, the lid 201 secured over an edge 202 of the open top side 103 of the container. In another embodiment, the lid 201 is secured via a friction fit within the open top side 103 of the stackable medication crushing container. In one embodiment, the lid 201 will create a waterproof seal such that liquids are contained within the stackable medication crushing container.

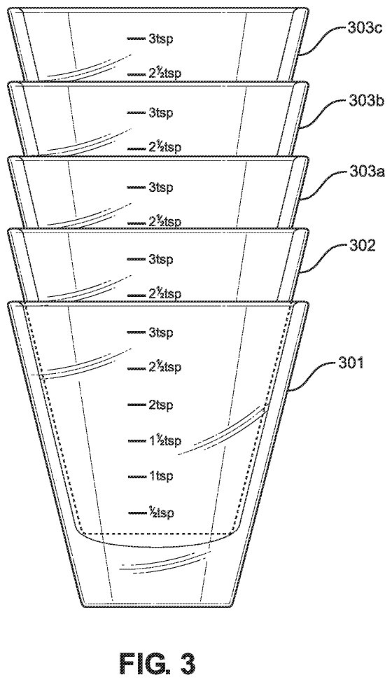

Referring now to FIG. 3, there is shown a side view of an embodiment of several stackable medication containers. In the shown embodiment, there is five stackable medication crushing containers, however, it is envisioned that any number of containers may be stacked. When stacked a first container 301 will have a second container 302 placed within the first container 301. When the containers are stacked, they will be able to hold a medication in a gap formed between the base of the first container 301 and the base of the second container 302. In the shown embodiment there are further containers 303a, 303b, and 303c. Each of these containers is stacked and secured within the preceding container.

The containers will seal together when stacked. In some embodiments, the containers will fit together via friction fit. In other embodiments, the containers will be held together via a clasp. In the embodiment where there is a clasp the exterior of the container has an indent. In this embodiment the clasp is hingedly connected to the exterior of the container. The clasp further has a pin located at the end opposite the hinge connection. When moved into the locking position the pin will engage with an indent of a different container locking the containers together. In yet another embodiment, a securement device is located around the exterior of the stackable medication crushing container and will hold the containers together. In an embodiment where the first container 301 and the second container 302 are stacked, the first and second containers 301, 302 form a waterproof seal. This will allow the containers to hold liquid medication.

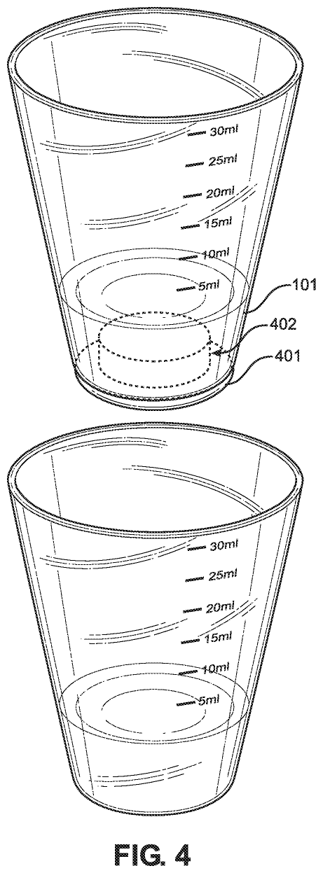

Referring now to FIG. 4, there is shown a side view of an embodiment of a pair of stackable medication containers with a crushing element. In one embodiment, the stackable medication crushing container has an insertable crushing element 401. In an embodiment, the base 101 of the stackable medication crushing container has an indented portion 402 that indents into the base 101 from the underside of the base 101. The indented embodiments are not limited to the embodiments that include an insertable crushing element 402. The indented portion 402 can also serve to allow for extra volume within the gap formed between containers when stacking the containers.

The insertable crushing element 401 is designed to frictionally fit within the indented portion 402. The crushing element 401 is further configured to fit within the container. This will allow for the insertable crushing element 401 to be inserted into a first container. Then the first container can be inserted into a second container and be used to crush a medication located therein. In one embodiment, the insertable crush element 401 is created from a single rigid material that will crush a medication. In another embodiment, the insertable crushing element 401 is made from two materials. A first material is a rigid crushing material that is capable of crushing medications. A second material is a softer material such as rubber that will grip to the stackable medication crushing container. This configuration will make for a better friction fit for the insertable crushing element 401.

The crushing element 401 has a base having a first side and a second side. The second side has a rounded portion that is configured to match the bottom interior of a container. The top side is a planar surface. The planar surface has a protrusion rising therefrom. The protrusion is configured to fit within the indented portion 402 of the medication container.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A stackable medication crushing container, comprising:
a container having a base and a cylindrical sidewall;
wherein the cylindrical sidewall comprises indicia placed vertically along the sidewall in at least two places;
wherein the container is configured to be placed within a second like container and fastened therein.

2) The stackable medication crushing container of claim 1, further comprising an indented portion, wherein the indented portion is a volume formed on an underside of the base.

3) The stackable medication crushing container of claim 2, further comprising a crushing element secured within the indented portion of base.

4) The stackable medication crushing container of claim 3, wherein the insert is a crushing insert, the insert is proportioned to fit flush within the interior of a second like container.

5) The stackable medication crushing container of claim 1, further comprising a lid that is capable of being removably secured to a top side of the container.

6) The stackable medication crushing container of claim 1, wherein a first set of vertical indicia indicate the volume of the container in milliliters.

7) The stackable medication crushing container of claim 1, wherein a first set of vertical indicia indicate the volume of the container in teaspoons and tablespoons.

8) The stackable medication crushing container of claim 1, wherein the cylindrical wall tapers inward from a top side of the container towards the base.

9) A pair of stackable medication crushing containers, comprising:
a pair of stackable containers;
wherein each container has a base and a cylindrical sidewall;
wherein the cylindrical sidewall of each container has indicia placed vertically along the sidewall in at least two places;
wherein the containers are configured to be removably secured together such that one container is within the other container.

10) The pair of stackable medication crushing containers of claim 9, further comprising an indented portion located in an underside of the base of each container.

11) The pair of stackable medication crushing containers of claim 10, further comprising an crushing element that is configured to be fit within the opening located on the underside of the base of each container.

12) The pair of stackable medication crushing containers of claim 11, wherein the insert is a crushing insert, the insert is proportioned to fit flush within the interior of each container.

13) The pair of stackable medication crushing containers of claim 9, further comprising a lid that is capable of being removably secured to a top side of each container.

14) The pair of stackable medication crushing containers of claim 1, wherein a first set of vertical indicia indicate the volume of each of the containers in milliliters.

15) The pair of stackable medication crushing containers of claim 9, wherein a first set of vertical indicia indicate the volume of each of the containers in teaspoons and tablespoons.

16) The pair of stackable medication crushing containers of claim 9, wherein the cylindrical wall of each container tapers inward from a top side of the container towards the base.

17) The pair of stackable medication crushing containers of claim 9, wherein the containers are proportioned to be held together via friction.
